(19) United States
(12) Patent Application Publication
(10) Pub. No.: US 2026/0283755 A1
(43) Pub. Date: Sep. 24, 2026

(54) Dispensing Device for Dental Materials with Volume Flow Measurement Device

(71) Applicant: Kulzer GmbH, Hanau (DE)

(72) Inventor: Mike Kondziela, Weilburg (DE)

(21) Appl. No.: 19/479,795

(22) PCT Filed: Apr. 19, 2024
(86) PCT No.: PCT/EP2024/060692

§ 371 Date: Oct. 29, 2025

(30) Foreign Application Priority Data
May 2, 2023 (DE) 10 2023 111 263.5

(51) Int. Cl. A61C 9/00

(52) U.S. Cl. CPC A61C 9/0006; A61C 9/0026

(57) ABSTRACT

The disclosure relates to a dispensing device for dental materials from a cartridge system, the dispensing device having a motor, a holder, a motor controller, an actuator and a volume flow measurement device for determining the dispensed volume or volume flow, wherein by means of the actuator a discharge plunger of a cartridge system can be driven, the actuator can be driven by means of the motor, the volume flow measurement device has a sensor which is connected to a processor connected to the motor controller for evaluating measurement signals, wherein the processor is designed for evaluation such that the volume or volume flow of dispensed dental material can be determined. The disclosure also relates to a method for dispensing a dental material, in particular a dental impression compound, from a cartridge system using a dispensing device, at least one impression tray with a machine-readable identification and a system consisting of such a dispensing device and at least one such impression tray.

The invention relates to a dispensing device for dental materials, in particular for dental impression materials, and to a method for dispensing a dental material, in particular a dental impression material, from a cartridge system using a dispensing device.

Modern dental impression compounds are mainly provided in cartridge systems, in particular in two-component cartridges, which are mechanically or electrically dispensed by means of a dispensing device and mixed. Such a hand-held dispensing device is known for example from WO 2017/207188 A1 and EP 3 718 501A1. A single-chamber cartridge for self-hardening or moisture-hardening materials, as are used for example for sealing in construction, is known from U.S. Pat. No. 5,909,830 A. For such purposes, pneumatically or electrically driven dispensing devices are also commercially available on the market. However, these are not readily suitable for dispensing dental impression compounds.

For directly applying dental impression compounds in the patient's mouth, smaller two-component cartridges having two chambers and a content of 5 ml to 100 ml have become established. A dispensing device for systems having such small volumes is known for example from US 2018/0250103A1. However, there are also smaller, serially arranged cartridges having volumes of less than 5 ml. The dental impression compound is placed into a dispensing device, also referred to as a “dispensing gun”, and mechanically conveyed by means of a toothed rod acting on discharging plungers in the cartridge. The mixer is statically designed in this case.

These cartridges and such cartridge systems are used for thin-flowing to highly viscous materials (types 1 to 3 according to DIN ISO 4823:2015, publication date 2015 August). p Wherein the impression compounds of higher viscosities (type 1) strain the users due to high squeeze-out forces.

A ray for the locally limited application of a dental impression material is known from WO 2017/048918A1. An impression tray that can be assigned to a specific patient is known from EP 3 037 059A1. US 2010/0075273 A1 discloses a further tray for receiving a dental impression material for the purpose of taking an impression in a patient's mouth.

Generic electric extrusion devices, also known as dispensing devices, are known from US 2009/279382A1, US 2015/157429A1, and DE 20 2006 006 147U1. Such dispensing devices may have a base and are used primarily to mix and dispense dental material from larger cartridges with a total capacity of, for example, 350 ml to 400 ml, and are usually used in a stationary manner. Dental impression materials provided by such dispensing devices are used to fill dental impression trays, which are used to take impressions in a patient's mouth. Dispensing devices may be equipped with a mixer, which can also be electrically driven.

When filling a dental impression tray using such a dispensing device with an integrated mixer and cartridge systems with large cartridges with a capacity of 380 ml, the user operates a feed button or a control element on the dispensing device and fills a suitable dental impression tray. The amount of impression material is estimated by the user. By pressing the feed button or control element, the dispensing device feeds the dental material for as long as the feed button or control element is pressed. The dental impression tray must be swiveled under the outlet opening of the dispensing device in order to fill all areas of the dental impression tray. This manual process must be performed by the user with both hands. With a wide variety of impression trays, this process requires routine and concentration.

Dental impression trays are available in different sizes to suit the different mouth sizes of different patients, so filling them requires a certain amount of routine on the part of the user. In the worst case, the dental impression tray is underfilled and the dental impression taken is incomplete. The process must then be repeated. However, overfilling the dental impression tray can also lead to problems, as the excess dental impression material can enter the throat and cause the patient to gag, which, apart from being unpleasant, can also lead to the impression being interrupted and the loss of the impression material.

One task of the invention is to at least partially overcome one or more disadvantages of the prior art. One of the objectives can be to simplify the use of the dispensing device for the user. Simplification can be seen in the fact that further automation of the dispensing of dental material is made possible. One objective of the invention is, in particular, to provide the user with the correct filling quantity of dental impression material for specified impression trays by means of a programmed or programmable delivery quantity.

The tasks of the invention are at least partially solved by a dispensing device for dispensing a dental material, in particular a dental impression material, from a cartridge system, the dispensing device comprising a motor, in particular a stepper motor, the dispensing device further comprising a holder for attaching a cartridge system, a motor control, an actuator, and a volume flow measuring device for determining the volume or a volume flow of a dental material dispensed from the dispensing device, wherein at least one discharge piston of a cartridge system fixed in the dispensing device with the holder is propellable by the actuator, wherein the actuator is drivable with the motor or a mechanically transmitted driving of the actuator is supportable by the motor, wherein the volume flow measuring device has at least one sensor, wherein the at least one sensor is connected to a processor for evaluating measurement signals from the at least one sensor, wherein the processor is connected to the motor control, and wherein the processor is designed or programmed to evaluate the measurement signals in such a way that the volume or volume flow of the dental material dispensed from the cartridge system by the propulsion of the at least one discharge piston from the cartridge system is determinable.

The dental material may be an impression material or a dental adhesive or dental cement. The dental material is particularly preferably a dental impression material.

The dental material may be a viscous dental material, in particular a highly viscous dental material.

The holder for securing the cartridge system in the dispensing device should be able to secure or fix the cartridge system in the dispensing device in such a way that at least one discharge piston in at least one cartridge of the cartridge system is drivable in the direction of at least one outlet opening of the cartridge with the aid of the actuator.

The cartridge system preferably has at least one cartridge, each with a cylindrical interior, wherein a discharge piston is arranged in the at least one interior of the at least one cartridge, which is movably mounted in the direction of a cylinder axis of symmetry of the at least one interior, wherein at least one opening for dispensing the contents of the at least one cartridge is arranged at one end of the cartridge, and wherein the dental material or starting components of the dental material are contained between the opening for dispensing and the at least one discharge piston.

The cartridge system particular preferably comprises two adjacent cartridges, each with a cylindrical interior, wherein a discharge piston is arranged in the interior of each of the two cartridges, wherein the discharge pistons are movably mounted in the direction of a cylinder axis of symmetry of the respective interior, wherein at least one opening for dispensing the contents of the two cartridges is arranged at one end of each of the two cartridges, and wherein the starting components for producing the dental material are contained between the opening for dispensing and the discharge piston. By driving the discharge pistons with the actuator, the starting components are then expelled from the two cartridges and mixed together within the dispensing device, thereby producing the dental material. For this purpose, the dispensing device may comprise a mixer, in particular a static mixer, through which the starting components are pressed by means of the pressure on the discharge pistons. After mixing, the dental material is discharged from the dispensing device. The energy required for this is supplied by the motor of the dispensing device, which drives the actuator.

In a cartridge system with only one cartridge, the motor of the dispensing device also provides the energy required to expel the dental material from the cartridge.

It may be provided that at least two starting components for producing the dental material are contained or stored in the cartridge system and that the dispensing device is designed to mix the at least two starting components with each other within the dispensing device. The mixing of the at least two starting components may be driven or drivable by the propulsion of the actuator.

The volume flow measuring device is a device with which the volume flow or the volume of the dental material dispensed from the dispensing device can be determined, whereby a measuring signal from at least one sensor is evaluated with the aid of the processor. The volume of dental material dispensed from the dispensing device over a specific period of time or the volume flow of the dental material dispensed from the dispensing device can be determined with the aid of the volume flow measuring device. The dispensed volume can be calculated from the volume flow over time (for example, integrally). Conversely, the volume flow can also be calculated from the temporal sequence of dispensed volumes. The processor can be designed as a single unit with the motor control as a common control.

A volume flow is to be understood as the dispensing of a volume in a specific unit of time, or the dispensed volume per unit of time.

According to the invention, an actuator is defined as a part of the dispensing device with which linear propulsion of at least one discharge piston or the at least one discharge piston of the cartridge system can be effected. The actuator can preferably be a linearly propellable plunger or a linearly propellable rod or pairs thereof. However, other actuators are also conceivable, such as a link chain.

The motor can be connected directly or indirectly to the actuator.

The motor is preferably a stepper motor. The sensor or one of the sensors of the at least one sensor is preferably a step counter of the stepper motor.

The fact that the motor can support the mechanically transmitted drive of the actuator means that part of the force for driving the actuator is applied by the motor. For example, the actuator can be driven both manually and by the motor at the same time, for example by manually operating a lever or crank or similar, thereby using the force applied by the user to drive the actuator, while at the same time the motor also applies the remaining force necessary to drive the actuator.

According to the invention, it may be provided that the at least one sensor is a volume flow sensor, a step counter for determining the number of revolutions of the motor, in particular a step counter for determining the number of steps of the stepper motor, and/or a position sensor for determining the position of the at least one discharge piston and/or the actuator relative to the holder for fastening the cartridge system, wherein the dispensed volume of the dental material is determinable by measuring the volume flow of the dental material with the volume flow sensor and/or by determining the number of revolutions of the motor or the steps of the stepper motor and a known volume of the dispensed dental material per revolution of the motor or per step of the stepper motor and/or by determining the position of the at least one discharge piston and/or the actuator and a known volume of the dispensed dental material per unit length of the position of the at least one discharge piston and/or the actuator relative to the holder.

Each of these measures allows the volume of the dispensed dental material to be determined and implemented in a simple and reproducible manner.

A volume flow sensor can be, for example, a vane meter or a rotating screw conveyor (which may also be driven by a separate motor) of a mixer, which can preferably be arranged in the area of a mixing device for mixing the starting components of the dental material. A potentiometric measuring arrangement, in which an electrical resistance is measured as a function of a protruding length section of the actuator, can be used as a position sensor, for example. Other methods for determining the volume or volume flow are generally known to those skilled in the art.

The fact that the position of at least one discharge piston and/or actuator and a known volume of the dispensed dental material per unit length of the position of at least one discharge piston and/or actuator relative to the holder can be determined does not mean that this must be measured directly on the holder. Any other part of the dispensing device that is arranged in a defined and known local relation to the holder can be used for the measurement.

Furthermore, it may be provided that the dispensing device has a volume flow regulator, wherein the volume flow regulator is connected to the volume flow measuring device and the motor control and wherein a volume of the dental material to be dispensed from the dispensing device is controllable and/or adjustable by the volume flow regulator and/or a volume flow of the dental material dispensed from the dispensing device is controllable and/or adjustable by the volume flow regulator.

This allows the dispensing device to be used to set and dispense a specific volume flow or a specific volume of dental material dispensed from the cartridge system.

Furthermore, it may be provided that the dispensing device has an electronic memory and an input device, wherein several different volumes are selectable via the input device and, by means of the motor control, the selected volumes are extrudable fully automatically by the dispensing device from a cartridge system fixed by the holder in the dispensing device.

This further simplifies the use of the dispensing device for the user.

The input device should be manually operable. The entire discharge device should not be completely manually operable, as the actuator is motor-driven or at least motor-assisted. The input device should be manually operable.

In order to retrieve stored volumes of the dental material to be dispensed, the input device and/or the processor may be connected to the electronic memory, and the electronic memory and/or the input device may be connected to the processor and/or the motor control.

In dispensing devices with an input device, it may be provided that a volume or measured volume flow or measured temporal volume flow curve of the dental material, which was previously dispensed with the dispensing device by means of individual and manual settings and measured with the volume flow measuring device, can be stored in the electronic memory via an input on the input device, and that this volume and/or or the necessary volume flow of the dental material and/or its temporal progression and the required temporal control of the motor can be retrieved from the electronic memory via the input device and reproduced with the dispensing device.

This means that individual settings and processes can also be stored with the dispensing device and retrieved later.

Furthermore, it may be provided that the several different volumes that are selectable via the input device are identifiable at the input device by a label on a container to be filled with the dental material, in particular by means of a number and/or letter identification of the container to be filled with the dental material so that the input is uniquely assigned to a container with a suitable volume for receiving the dental material.

Thereby it can preferably be provided that the container is an impression tray and the dental material is a dental impression compound.

This makes it easy for the user to identify the program assigned to the dispensing device and the corresponding container, thereby further facilitating the successful operation and use of the dispensing device.

According to a preferred embodiment it may also be provided that the dispensing device has a residual quantity indicator and a residual quantity calculation module, wherein the residual quantity calculation module is connected to the volume flow measuring device and wherein the residual quantity calculation module is programmed such that it determines, stores, or reads-in the producible volume of dental material by the cartridge system fixed to the holder when in completely filled state, or the producible volume of dental material is definable by an input, and the residual quantity calculation module subtracts the volume previously produced with this cartridge system from this producible volume of dental material in order to calculate a residual quantity, whereby the residual quantity calculated with the residual quantity calculation module is displayable on the residual quantity display.

There, it can further be provided that the residual quantity calculation module is programmed such that, when a small residual quantity is calculated, it selects a suitable container, in particular a dental impression tray, with a receiving volume suiting to the remaining residual quantity and suggests the suitable container on the residual quantity display.

It can also be provided that the residual quantity calculation module is programmed such that, when a volume to be dispensed is selected which, according to the calculated residual quantity, is no longer contained in the attached cartridge system or cannot be produced with it, a corresponding message is displayed on the residual quantity display, in particular a prompt to change the cartridge system, and/or a maximum available volume of the dental material is displayed.

This allows the user to immediately see whether the next volume of dental material to be dispensed can still be dispensed using the cartridge system that has already been opened and is attached to the dispensing device, or whether a new or unused cartridge system must or should be used.

Furthermore, it can be provided that the dispensing device has a scanner for reading an identifier of the cartridge system attached to the holder or an identification sensor for identifying the cartridge system attached to the holder, wherein preferably the identifier read by the scanner or the identification determined by the identification sensor is preferably transmitted to the processor or to the residual quantity calculation module for identifying the contents of the cartridge system and/or the volume of dental material that is producible with the cartridge system.

This further simplifies the use of the dispensing device.

According to the invention, an RFID reader that reads an RFID chip in the cartridge system can be used as the identification sensor. Alternatively, the identification sensor can also determine the length and/or diameter of two cartridges in the cartridge system and derive suitable information from this.

Other information relating to the contents of the cartridge system can also be transmitted via an RFID chip, a QR code, or a hologram of the cartridge system and then be processed and used by the dispensing device, such as information on the shelf life and/or composition of the contents of the cartridge system. Within the scope of the present invention, it may be provided that, when it is determined that the shelf life has been exceeded and/or that the contents are undesirable, dispensing is prevented or at least a corresponding warning message is sent to the user.

It may be provided that at least one plate is attached to a front side of the actuator, with which at least one discharge piston of the cartridge system is to be pressed into the at least one cartridge of the cartridge system.

Furthermore, it may be provided that the dispensing device is suitable for extruding cartridge systems for dental impression materials, in particular two-component cartridges for dental impression materials, wherein preferably the cartridge system provides a volume of between 100 ml and 1000 ml of dental impression material, particularly preferably a volume of between 250 ml and 600 ml of dental impression material, and most preferably a volume of between 300 ml and 500 ml of dental impression material.

This allows dental impression materials to be dispensed in the desired quantities using the dispensing device.

The cartridge system may preferably be part of the dispensing device according to the invention, in particular a replaceable part of the dispensing device according to the invention.

It can also be provided that the dispensing device is suitable for extruding cartridge systems at least for dental impression materials of type 1 and/or type 2 according to DIN ISO 4823:2015.

This allows commercially available dental impression materials to be dispensed in the desired quantities using the dispensing device.

It can be provided that the dispensing device has a reader for reading an identifier of a container, in particular a dental impression tray, wherein the reader is connected to the processor and the processor is programmed such that, depending on the container recognized by the reader, in particular the recognized dental impression tray recognized by the reader, a volume, a volume flow and/or a time curve of the volume flow suitable for the recognized container, in particular for the recognized dental impression tray, is selectable and providable by corresponding control of the motor.

This further simplifies the use of the dispensing device.

According to the invention, the dispensing device may also be provided with a reader for reading an identifier of the container or the dental impression tray. This further reduces the possibility of operating errors. The reader may be a scanner, a hologram scanner, a barcode scanner, a QR code scanner, or an RFID tag reader. For this purpose, each container or impression tray may be provided with a machine-readable label, a hologram, a barcode, a QR code, or an RFID chip, which allows unique assignment to a specific volume flow, volume, or time course of the volume flow. Such a reader can be provided as part of an input device, instead of the input device, or in addition to an input device. When the container or dental impression tray approaches and is successfully recognized by the reader, the appropriate volume, volume flow, or program can already be suggested, which the user then only has to activate or confirm.

The tasks underlying the present invention are also solved, at least in part, by a method for dispensing a dental material, in particular of a dental impression material, from a cartridge system by means of a dispensing device, characterized by the steps
A) Securing the cartridge system in the dispensing device,
B) Actuating an actuator of the dispensing device with a motor, wherein the actuator drives at least one discharge piston of the cartridge system in at least one cartridge of the cartridge system forward,
C) Dispensing a dental material or starting components of the dental material from the cartridge system by driving the at least one discharge piston in the at least one cartridge forward, whereby the dental material is dispensed from the at least one cartridge or is produced by mixing and dispensing the starting components from the at least one cartridge,
D) Measuring the volume flow and/or the volume of the dental material dispensed by the dispensing device and determining the volume of dental material dispensed by the dispensing device, and
E) Stopping the actuation of the actuator of the dispensing device when a target volume of the dispensed dental material is reached and/or controlling the volume flow of the dispensed dental material in order to set a target volume flow of the dispensed dental material or to set a desired time curve of the volume flow of the dispensed dental material.

It is preferable that the method is not a method for treating a human or animal body.

An offset can be taken into account for the target volume in order to compensate for the dental material flowing after the actuator has stopped moving. Such flow can occur in particular with viscous and highly viscous dental materials because the parts of the cartridge system and also the dispensing device can deform elastically and dental material flows when they return to their original form.

In the methods according to the invention, it may preferably be provided to carry out the method using a dispensing device described above or herein.

The method then has the advantages that can be achieved with the dispensing device and mentioned above.

For methods according to the invention it may also be provided that the target volume and/or the target volume flow and/or the desired time curve of the volume flow is or are determined and defined by previously dispensing dental material with manual settings and measuring the volume flow and/or the volume, wherein preferably the target volume and/or the target volume flow and/or the desired time curve of the volume flow is or are retrievably stored in an electronic memory, wherein it is particularly preferred that the time curve of the dispensing process is additionally stored in the electronic memory.

This means that individual settings and processes can also be stored with the dispensing device and retrieved later.

It can also be provided that the target volume is selected from a plurality of previously stored target volumes, preferably selected to match a plurality of containers for receiving the dental material.

It can also be provided that the target volume flow is selected from a plurality of previously stored target volume flows, preferably selected to match a plurality of containers for receiving the dental material.

Furthermore, it can be provided that the desired time curve of the volume flow is selected from a plurality of previously stored time curves of volume flows, preferably selected to match a plurality of containers for receiving the dental material.

This simplifies the application of the method.

Preferably it can be provided that the volume of dental material dispensed by the dispensing device, determined by measuring the volume flow and/or the volume and/or the timer curve of the volume flow, is subtracted from a known residual amount of the available dental material that is extrudable from the cartridge system and the remaining quantity is displayed on a display and/or is taken into account in a subsequent dispensing process in such a way that the dispensing process is only started if a sufficient remaining quantity for the volume of dental material to be dispensed is available in the cartridge system and otherwise a warning or a prompt to change the cartridge system is displayed.

This allows the user to immediately see whether the next volume of dental material to be dispensed can still be dispensed using the cartridge system that has already been opened, or whether a new cartridge system needs to be inserted.

Furthermore, it can be provided that the dispensing device has a scanner for reading an identifier of the cartridge system fixed in the holder or has an identification sensor for identifying the cartridge system fixed in the holder, wherein the identifier of the cartridge system is read by the scanner or the identification of the cartridge system is determined by the identification sensor and subsequently the identifier or the identification is used to identify the contents of the cartridge system and/or the volume of dental material that can be produced with the cartridge system, wherein preferably the identifier or identification is taken into account during the dispensing process, at the start of the dispensing process, and/or during a calculation of the remaining quantity available in the cartridge system.

This further simplifies the use of the dispensing device and increases user comfort.

It can also be provided that the dispensing device has a reader for reading a machine-readable identifier of a container, in particular of a dental impression tray, wherein the identifier is read and subsequently the identifier is used to identify the container, in particular a shape or a volume of a cavity of the dental impression tray as a container, wherein the target volume, the volume flow and/or the time curve of the volume flow of the dental material is set or controlled as a function of the identifier of the container.

This prevents incorrect operation of the dispensing device and further simplifies the implementation of the method according to the invention.

The tasks underlying the present invention are also solved, at least in part, by a dental impression tray for receiving a dental impression material, the dental impression tray comprising a handle for holding the dental impression tray and a cavity for receiving the dental impression material, wherein the dental impression tray has a machine-readable identifier arranged on an outward-facing surface of the dental impression tray, preferably arranged on a side of the surface of the impression tray opposite the handle, wherein the machine-readable identifier contains information from which the geometric shape, volume, length, and/or width of the cavity can be read.

It is intended that the machine-readable identifier be located on an outward-facing surface of the dental impression tray, preferably on a side of the impression tray surface opposite the handle.

It can be provided that the machine-readable identifier is a hologram, a barcode, a QR code, a machine-readable label, a graphic imprint, a machine-readable sticker, or an RFID chip, preferably a hologram, a barcode, a QR code, or an RFID chip.

Furthermore, it may be provided that the machine-readable identifier contains information from which the geometric shape, volume, length, and/or width of the cavity is readable.

This enables clear allocation and automated use of the impression trays.

According to the invention a plurality of dental impression trays may be provided, wherein each dental impression tray has a different machine-readable identifier that allows identification of the shape and/or volume of the cavity.

The tasks underlying the present invention are also solved, at least in part, by a system for taking an impression with a dental impression material, comprising a previously described dispensing device with a reader for reading an identifier of a container, in particular a dental impression tray, and comprising at least one previously described dental impression tray or the previously described plurality of dental impression trays.

The invention is based on the surprising findings that the use of a volume flow measuring device, which is connected to a processor for determining the volume or volume flow dispensed from the cartridge system, simplifies the use of the dispensing device for the user in that enabling automated and standardized filling of containers such as dental impression trays and also providing the option of displaying the remaining amount of dental material that can still be dispensed, so that using the dispensing device requires less concentration and skill and the user can see at a glance whether a sufficient amount of dental material can still be dispensed with the cartridge system used. These measures improve the user-friendliness of the dispensing device. At the same time, unnecessary waste of dental material due to excessive filling or repeated filling of the dental material due to incorrect operation is prevented.

According to the invention, the delivery rate per button press or per operation can be controlled by a control program in the processor or in the motor control of the dispensing device, which controls the feed of the actuator and thus the movement of the discharge pistons (or at least one discharge piston) in the cartridges (or in the cartridge) of the cartridge system per work cycle and thus the delivery rate of the dispensed dental material. For example, the user presses a program button “1” and, for example, 55 ml of dental impression material is delivered to the dental impression tray. The delivery quantity is preferably already matched to the dental impression tray used and selected. The dental impression tray also has a marking with the number “1” or a suitable character string for accurate and quick assignment. The tray assortment is numbered and for each number there are corresponding delivery programs in the dispensing device that are matched to the tray contents.

Instead of a marking with a number or a character string, an identifier with a hologram, a QR code, a barcode, or a readable RFID chip may also be provided, which is read or scanned by a reader of the dispensing device, and the volume of the dental impression material is assigned accordingly.

In a preferred further development of the invention, the dispensing device remembers or stores the dispensed quantity, adds it up, and calculates the available remaining quantity of dental material. When emptying the remaining material, an impression tray can be suggested, for example, which can still be filled with the remaining quantity of dental material in the cartridge system.

Preferably, at least one additional button can be freely programmed by the user. Here, the quantity (volume) and/or duration and/or time course of the delivery can be individually set and defined using a program. This means that dental impression trays outside the user's own numbered range can also be programmed.

The advantage of the solution according to the invention is that even inexperienced users can fill the dental impression trays to the ideal size.

In addition, less dental material waste is generated.

Furthermore, according to the invention, better utilization of residual quantities when filling the last dental impression tray is made possible by means of a quantity display and program-controlled selection of a suitable dental impression tray as a container for receiving the dental material.

In the following, further embodiments of the invention are explained with reference to two schematic figures, without however limiting the invention. These show:

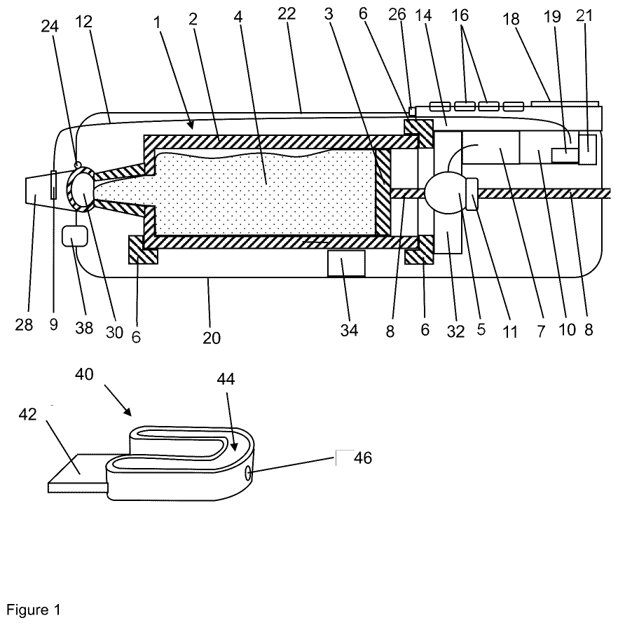

FIG. 1: a schematic cross-sectional view of a dispensing device according to the invention, in which a cartridge system is affixed, with a container for holding a dental material; and

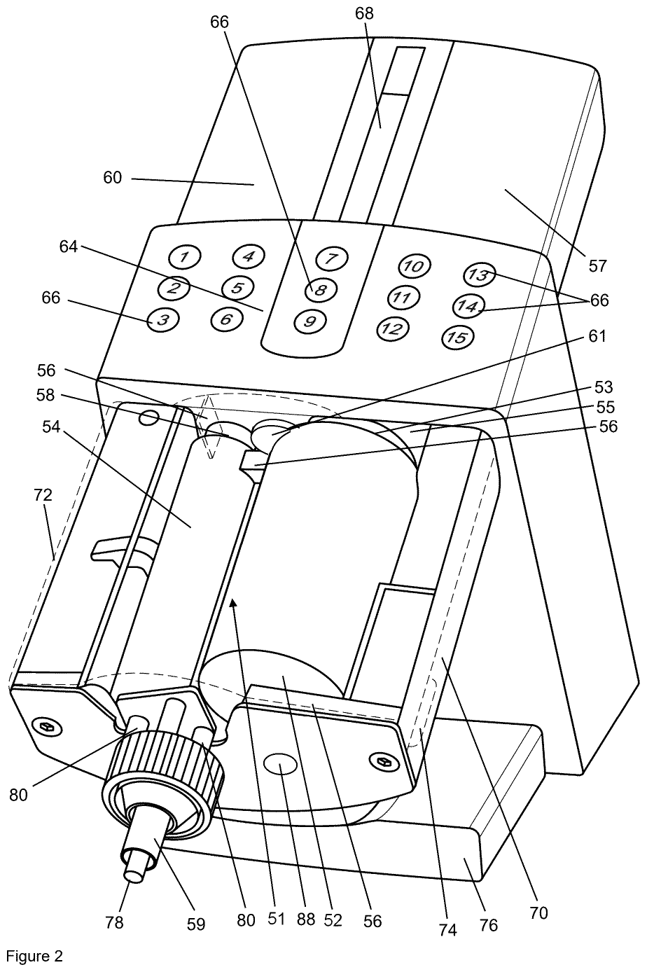

FIG. 2: a schematic perspective view of another dispensing device according to the invention with a transparent lid (dashed line), in which a cartridge system containing the starting components for a dental impression material is inserted and secured.

FIG. 1 shows (in FIG. 1 above) a schematic cross-sectional view of a dispensing device according to the invention into which a cartridge system 1 can be inserted. The cartridge system 1 can have one or more cartridges 2. Each cartridge 2 has a discharge piston 3 with which a starting component 4 for producing a dental material can be expelled from the cartridge 2. The cartridge system 1 may contain starting components 4 of a dental material, in particular of a dental impression material, which can be mixed with the dispensing device to produce the dental material, in particular the dental impression material. The cartridges 2 can be arranged one behind the other in the image plane of FIG. 1, so that only one of two cartridges 2 is visible in FIG. 1 and the other is concealed by the cartridge 2 shown in section. The cartridges 2 are then arranged parallel to each other, analogous to the parallel arrangement shown in FIG. 2. However, it is also possible that the cartridge system 1 has only one cartridge 2, in which case the starting component 4 is the dental material itself. The cartridge system 1 can be fixed in the dispensing device in a desired position and orientation of the cartridge(s) 2 using a holder 6 of the dispensing device.

The dispensing device has a motor 5 with which the movable parts mounted in the dispensing device can be driven to press out the starting components 4. The dispensing device has a motor control 7 with which the motor 5 can be controlled. For this purpose, the motor control 7 is connected to the motor 5, for example via a cable and an interface.

The dispensing device has an actuator 8, which can be designed as a push rod. The actuator 8 can also be implemented by two push rods arranged parallel to each other in order to be able to extrude the contents of two cartridges 2 arranged parallel to each other. The actuator 8 can be driven by the motor 5. In a preferred embodiment, the motor 5 can be designed as an electric motor, in particular as a stepper motor. The motor 5 may be connected to the actuator 8 via a coupling and a gearbox. In addition, a drive shaft can also be provided. The actuator 8 may be driven linearly with the motor 5 in an axial direction so that the actuator 8 drives the discharge piston or pistons 3 in the cartridge or cartridges 2. The motor 5 can, for example, drive at least one gear wheel (not shown), whereby the actuator 8 can then preferably have at least one rack or be designed as at least one rack, so that by turning the at least one gear wheel, the at least one rack and thus the actuator 8 is driven linearly in the axial direction. Other ways of driving the actuator 8 with the help of the motor 5 are generally known and can also be used. To supply power to motor 5, the dispensing device may contain an energy storage device in the form of several accumulators or battery cells, or the dispensing device may have a mains connection for power supply (not shown). Theoretically, a compressed gas cartridge can also be used as an energy storage device, or a compressed gas connection can be provided if a compressed air motor is used as motor 5.

The dispensing device may comprise a volume flow measuring device with a sensor 9 and/or a sensor 11 and a processor 10, wherein the sensor 9 and/or the sensor 11 may be connected to the processor 10 via a connection 12, such as a line. The processor 10 is preferably programmed or designed to evaluate the measurement signals from the sensor 9 and/or the sensor 11. The sensor 9 may be arranged in the area of a discharge opening 28 of the dispensing device through which the dental material (if necessary after mixing the starting components 4) is discharged from the dispensing device. The sensor 11 can be a sensor for determining the position and change in position of the actuator 8, which determines the position of the actuator 8, whereby the processor 10 uses this to calculate the volume, the volume flow, and/or the change in the volume flow of the dental material over time.

Alternatively or additionally, a step counter of the motor 5 can also be used as a sensor for the volume flow measuring device.

An input device 14 in the form of a control panel may be provided on the upper side of the dispensing device. The input device 14 may have several switches, buttons, and/or keys 16 as well as a display 18. The display 18 may be a pure display or may also be designed as a touchscreen.

The input device 14 can be connected to the display 18 with the processor 10. In this way, the inputs at the input device 14 can be processed directly by the processor 10. Similarly, information can be displayed to the user by the processor 10 on the display 18. In particular, the dispensing device can have a residual time calculation module 19, which can be implemented as part of the processor 10. The residual time calculation module 19 can be programmed or can be a program structure of the processor 10 to calculate a remaining quantity of the dental material in the actually used cartridge system 1 using a volume determined by the volume flow measuring device and a known filling quantity of the unused cartridge system 1. The residual quantity calculation module 19 can display the result of this calculation on the display 18, thereby informing the user of the quantity of dental material still available in the dispensing device and the cartridge system 1 currently contained in the dispensing device. It may also be provided that a warning message appears if a container (such as a dental impression tray) with a volume that is too large for the remaining quantity is selected and/or a container is suggested that matches the remaining quantity.

Preferably, the processor 10 may have an electronic memory 21 or be connected to an electronic memory 21. Preprogrammed dispensing processes can be programmed into the electronic memory 21. These preprogrammed dispensing processes can be assigned to specific container sizes (e.g., impression trays for dental impression materials), whereby individual preprogrammed dispensing processes can be assigned to individual buttons 16 of the input device 14. The user can then select a specific dispensing process suitable for a specific container, in particular a suitable volume, via one of the buttons 16, and the dispensing device can then carry out the desired dispensing process by suitably controlling the motor 5. The dispensing process may be monitored, controlled, and/or regulated using the sensor 9, the sensor 11, and/or the volume flow measuring device.

It may also be provided that the input device 14 with the display 18 is directly connected to the motor control 7.

The dispensing device may have a housing 20 with a closable lid 22. The lid 22 can be opened via a hinge 24 and closed by placing the side of the lid 22 opposite the hinge 24 against a stop 26. The housing 20 can also be made of plastic and/or be at least partially transparent to enable the user to determine by visual inspection whether a cartridge system 1 is inserted. The housing 20 serves to securely store the cartridge system 1 during the dispensing process. When the lid 22 is open, the cartridge system 1 can be replaced and a new cartridge system can be attached to the dispensing device by means of the holder 6.

The dispensing device may have a base (in FIG. 1, the flat underside of the housing 20) for setting up the dispensing device. Alternatively, a handle (not shown) may be arranged on one side of the dispensing device for manually holding the dispensing device. The dispensing device can thus be constructed in the manner of a cartridge gun. The user can hold the dispensing device with one hand on the handle. At least one additional button, switch, or trigger may be arranged on the handle as an operating device for the dispensing device. However, the dispensing device is preferably a stand-alone device with an input device 14 on the top of the dispensing device, as shown in FIG. 1.

At the tip of the actuator 8 (at the left end of actuator 8 in FIG. 1) a plate (not shown) can be provided, whereby pressure can be exerted on the discharge piston 3 of cartridge system 1 with one side of the plate in order to squeeze the starting component 4 out of cartridge 2 of cartridge system 1 and, if necessary, apply it as dental material after mixing.

The actuator 8 can be displaced axially against the holder 6 and the housing 20, so that a force can be exerted on a cartridge system 1 affixed to the holder 6 by moving the actuator 8.

A discharge pipe with an integrated static or active mixer can be arranged at the front of the dispensing device (on the left in FIG. 1), which opens into the discharge opening 28.

The contents of the cartridge(s) 2 can be mixed with the mixer when the contents of the cartridge(s) 2 are extruded.

The cartridges 2 can be connected to each other and to the discharge pipe via a conduit 30 in form of a pipe. The discharge pipe and the conduit 30 then form a T-piece that connects the two cartridges 2 and the discharge opening 28.

By pushing the discharge piston 3 or the discharge pistons 3, the contents of the cartridge(s) 2 can be dispensed through the discharge tube and the discharge opening 28. The discharge piston 2 or the discharge pistons 2 can be driven by the actuator 8 of the dispensing device when the cartridge system 1 is connected to the dispensing device.

The motor 5 can be connected to the housing 20 via a strut 32.

The dispensing device may have a scanner or identification sensor 34 with which the inserted cartridge system 1 can be read, identified, or determined. The scanner or identification sensor 34 can be connected to the processor 10 for this purpose. The scanner or identification sensor 34 can be used to determine the remaining amount of content for the residual quantity calculation module 19. The shelf life of the content or the composition of the content of the cartridge system 1 can also be determined and, if necessary, evaluated or used for other measures.

A reader 38 can be arranged on the front of the dispensing device, for example in the form of a scanner (e.g., a hologram scanner, a QR code scanner, or a barcode scanner) or in the form of an RFID reader. The reader 38 can be used to read or scan an identifier (e.g., a hologram, a QR code, a barcode, or an RFID chip) on a container 40, such as a dental impression tray 40. The information can be forwarded to the processor 10 in the same way as an input. The processor can then select a desired program from the electronic memory 21 that is suitable for the container 40, such as a specific volume, a specific volume flow, and/or a specific time course of a volume flow. The motor 5 is then controlled by the motor control 7 in accordance with the program.

A method according to the invention can proceed as follows, for example:

First, a cartridge system 1 with two cartridges 2 arranged parallel to each other is secured in the dispensing device with the aid of the holder 6. The lid 22 can then be closed.

Using the scanner or identification device 34, an identifier on the cartridge system 1 (e.g., a hologram, barcode, QR code, or RFID chip) can be scanned and stored in the processor 10 or in the memory 21 of the processor 10. In this way, the dispensing device has information about the contents of the cartridge system 1.

A specific volume suitable for a specific container 40 or dental impression tray 40 can then be selected via the input device 14. Alternatively or additionally, the reader 38 can be used to identify the container 40 to be filled, in particular the dental impression tray 40 to be filled, and a suitable program can be selected or suggested and confirmed via the input device 14. The processor 10 controls the motor control 7 according to the selected volume, thereby driving the motor 5.

The Motor 5 drives actuator 8 of the dispensing device, whereby actuator 8 drives at least one discharge piston 3 or the discharge pistons 3 of cartridge system 1 in at least one cartridge 2 of cartridge system 1.

This causes material to be dispensed from the cartridge system 1 by the advancement of the discharge piston(s) 3 in the cartridge(s) 2. The contents of the cartridges 2 are mixed in the static mixer in the discharge tube by the pressure on the discharge pistons 3, thereby producing the dental material, such as a dental impression material. The dental material is dispensed from the cartridges 2 and out of the discharge opening 28 and can be filled into the container, in particular the impression tray.

The amount of dispensed volume and the volume flow of the dental material are monitored by the volume flow measuring device and calculated by the processor 10. This determines the volume of dental material dispensed by the dispensing device. The control system uses the processor 10 to stop the motor 5 and thus the actuator 8 of the dispensing device when a target volume of the dispensed dental material is reached. In addition, the volume flow of the dispensed dental material can be controlled to set a target volume flow.

In addition to the volumes and volume flows stored in memory 21, an individually determined volume and an individually defined volume flow and temporal curve of a volume flow can also be stored. For this purpose, it can be entered via the input device 14 that the subsequent volume or the subsequent volume flow or the subsequent temporal volume flow sequence is to be linked to a previously selected assignment (for example, a specific key 16). Then, a volume or volume flow or temporal volume flow curve of the dental material is manually dispensed from the cartridge system 1 (for example, by pressing a specific key 16) and the volume and/or volume flow and/or temporal volume flow curve is determined using the volume flow measuring device. When the dispensing process is completed, the dispensed quantity (volume) of the dental material can be stored in the memory 21 and later retrieved and automatically dispensed. Similarly, a specific temporal volume flow profile can be generated, stored, and later selected, retrieved, and reproduced.

A residual quantity display can also be provided with the aid of the residual quantity calculation module 19.

The dispensing device can be used to fill a container 40, in particular a dental impression tray 40 as a container. A dental impression tray 40 according to the invention is shown in FIG. 1 below. The dental impression tray 40 may have a handle 42 for manually holding and operating the dental impression tray 40 and a cavity 44 for receiving the dental impression material or dental material that has been dispensed using a dispensing device according to the invention, such as the dispensing device shown in FIG. 1 or FIG. 2. In the dental impression tray 40 according to the invention, a machine-readable identifier 46 is arranged on a surface of the dental impression tray 40. The machine-readable identifier 46 can be read by the reader 38, thereby providing the dispensing device with information about the appropriate volume, the appropriate volume flow, and/or the appropriate time curve of the volume flow, and implementing this information with the processor in a manner appropriate to the recognized dental impression tray 40. The dental impression tray 40 is then filled at the push of a button or automatically and in accordance with the machine-readable identifier 46.

FIG. 2 shows a schematic perspective view of another dispensing device according to the invention with a transparent cover 72 (shown in dotted lines and transparent in FIG. 2), in which a cartridge system 51 containing the starting components for a dental impression material is inserted and secured.

The cartridge system 51 has two cartridges 52, 54 arranged parallel to each other. Each cartridge 52, 54 has a discharge piston 53, 58 with starting components (not visible) for producing a dental material, which can by dispensed from the interior of the cartridges 52, 54. The cartridge system 51 contains two starting components of a dental material, in particular a dental impression material, which can be dispensed from the cartridges 52, 54 using the dispensing device and mixed in the dispensing device to produce the dental material, in particular the dental impression material. The cartridge system 51 can be fixed in the dispensing device in a desired position and orientation of the cartridges 52, 54 using a holder 56 of the dispensing device.

The dispensing device has a motor 55 with which the movable parts mounted in the dispensing device can be driven to press out the starting components. The essential parts of the motor 55 are concealed in FIG. 2 and therefore cannot be seen, as the motor 55 is located inside the dispensing device. The dispensing device has a motor control 57 with which the motor 55 can be controlled. For this purpose, the motor control 57 can be connected to the motor 55, for example via a cable and an interface. The motor control 57 is preferably encapsulated and is preferably located inside the dispensing device.

The dispensing device has an actuator (not shown in FIG. 2 but analogous to FIG. 1), which can be designed as a pair of push rods. The actuator can be implemented by two push rods arranged parallel to each other in order to extrude out the contents of the cartridges 52, 54 arranged parallel to each other. The actuator can be driven by the motor 55. In a preferred embodiment, the motor 55 can be designed as an electric motor, in particular as a stepper motor. The motor 55 can be connected to the actuator via a coupling and a gearbox. In addition, a drive shaft can also be provided. The actuator can be driven linearly with the motor 55 in an axial direction of the actuator, so that the actuator drives the discharge pistons 53, 58 in the cartridges 52, 54. To supply power to the motor 55, the dispensing device may contain an energy storage device in the form of several accumulators or battery cells, or the dispensing device may have a mains connection for power supply (not shown). Theoretically, a compressed gas cartridge can also be used as an energy storage device, or a compressed gas connection can be provided if a compressed air motor is used as the motor 55.

The dispensing device may comprise a volume flow measuring device with a sensor 59 and/or a sensor 61 and a processor, wherein the sensor 59 and/or the sensor 61 may be connected to the processor via a connection, such as a line. Strictly speaking, the processor is located inside the dispensing device and may, for example, be located under the housing part 60 to the left of a display 68. The processor is preferably programmed or designed to evaluate the measurement signals from the sensor 59 and/or the sensor 61. The sensor 59 may be arranged in the area of a discharge opening 78 of the dispensing device through which the dental material (if necessary after mixing the starting components) is discharged from the dispensing device. The sensor 61 may be a sensor for determining the position and change in position of the actuator or at least one of the discharge pistons 53, 58 of the cartridge system 52, which determines the position of the actuator or the discharge pistons 53, 58, whereby the processor uses this to calculate the volume, the volume flow, and/or the change in the volume flow of the dental material over time.

Alternatively or additionally, a step counter of the motor 55 can also be used as a sensor for the volume flow measuring device.

An input device 64 in the form of a control panel may be provided on the upper side of the dispensing device. The input device 64 may have several switches, buttons, and/or keys 66 as well as the display 68. The display 68 may be a pure display, but theoretically it may also be designed as a touchscreen.

The input device 64 can be connected to the display 68 with the processor. In this way, the inputs at the input device 64 can be processed directly by the processor. Similarly, information can be displayed to the user by the processor on the display 68. In particular, the dispensing device can have a residual time calculation module that can be implemented as part of the processor. The residual time calculation module can be programmed or can be a program structure of the processor to calculate a remaining quantity of the cartridge system 51 in use based on a volume of the dental material already dispensed, determined by the volume flow measuring device, and a known filling quantity of the unused cartridge system 51. The residual quantity calculation module can display the result of this calculation on the display 68—for example, as a shrinking bar and/or with a color changing from green to red—and thus inform the user about the quantity of dental material still available in the dispensing device and the cartridge system 51 currently contained in the dispensing device. It may also be provided that a warning message appears when a container (such as a dental impression tray) with a volume that is too large for the remaining quantity is selected and/or a container is suggested that is suitable for the remaining quantity.

Preferably, the processor may have an electronic memory or be connected to an electronic memory. Preprogrammed dispensing processes can be programmed into the electronic memory. These preprogrammed dispensing processes can be assigned to specific container sizes (e.g., impression trays for dental impression materials), whereby individual preprogrammed dispensing processes can be assigned to individual buttons 66 of the input device 64. The user can then select a specific dispensing process suitable for a specific container, in particular a suitable volume, via one of the buttons 66, and the dispensing device can then carry out the desired dispensing process by suitably controlling the motor 55. The dispensing process can be monitored, controlled, and/or regulated using the sensor 59 and/or the volume flow measuring device.

The dispensing device may comprise a housing 70 with a closable transparent lid 72. The lid 72 can be opened and closed via hinges (not shown) on a lid handle 74. The housing 70 can also be made of plastic and be partially transparent, at least in the area of the lid 72, to enable the user to determine by visual inspection whether a cartridge system 51 is inserted or not. The housing 70 serves to securely store the cartridge system 51 during the dispensing process. When the lid 72 is open, the cartridge system 51 can be replaced and a new cartridge system can be attached to the dispensing device by means of the holder 56.

The dispensing device may have a base 76 for setting up the dispensing device. Theoretically, a handle (not shown) for manually holding the dispensing device may also be arranged on one side of the dispensing device. However, the dispensing device is preferably a stand-alone device with an input device 64 on the top side of the dispensing device opposite the base 76, as shown in FIG. 2.

A plate (not shown) may be provided at the tip of the actuator, whereby pressure can be exerted on the discharge pistons 53, 58 of the cartridge system 1 with one side of the plate in order to dispense the starting component out of the cartridges 52, 54 of the cartridge system 51 and apply it as dental material after mixing.

The actuator can be moved axially against the holder 56 and the housing 70, so that a force can be exerted on a cartridge system 51 attached to the holder 56 by moving the actuator.

A discharge pipe with an integrated static or active mixer can be arranged at the front of the dispensing device (at the front in FIG. 2), which opens into a discharge opening 78. The contents of cartridges 52, 54 can be mixed with the mixer when the contents of cartridges 52, 54 are dispensed.

The cartridges 52, 54 can be connected to each other and to the discharge pipe via conduits 80 in the form of pipes. The discharge pipe and the conduits 80 then form a pipe system that connects the two cartridges 52, 54 and the discharge opening 78 to each other.

The dispensing device may include a scanner or identification sensor (not shown) for reading, identifying, or determining the cartridge system 51 that is inserted. The scanner or identification sensor may be connected to the processor for this purpose. The scanner or identification sensor can be used to determine the remaining amount of content for the residual quantity calculation module 19. The shelf life of the content or the composition of the content of the cartridge system 51 can also be determined and, if necessary, evaluated or used for other measures.

A reader 88 may be arranged on the front of the dispensing device, for example in the form of a scanner (e.g., a hologram scanner, a QR code scanner, or a barcode scanner) or in the form of an RFID reader. The reader 88 can be used to read or scan an identifier 46 (e.g., a hologram, a QR code, a barcode, or an RFID chip) on a container 40, such as a dental impression tray 40. The information can be forwarded to the processor in the same way as an input. The processor can then select a desired program from the electronic memory that is suitable for the container 40, such as a specific volume, a specific volume flow, and/or a specific time curve of a volume flow. The motor 55 is then controlled by the motor control 57 in accordance with the program.

A method according to the invention can proceed as follows, for example:

First, a cartridge system 51 with two cartridges 52, 54 arranged parallel to each other is secured in the dispensing device with the aid of the holder 56. The cover 72 can then be closed. With the help of the scanner or identification device, an identifier on the cartridge system 51 (e.g., a hologram, a barcode, a QR code scanned, or an RFID chip read) can be read and stored in the processor or in the processor's memory. In this way, the dispensing device has information about the contents of the cartridge system 51.

A specific volume suitable for a specific container or impression tray (see, for example, FIG. 1 below) can then be selected using the input device 64. Alternatively or additionally, the reader 88 can be used to identify the container 40 to be filled, in particular the dental impression tray 40 to be filled, and a suitable program can be selected or suggested and confirmed via the input device 64. The processor controls the motor control 57 according to the selected volume, thereby driving the motor 55.

The motor 55 drives the actuator of the dispensing device, whereby the actuator drives the discharge pistons 53, 58 of the cartridge system 51 in the cartridges 52, 54 of the cartridge system 51.

This causes material to be dispensed from the cartridge system 51 by the forward movement of the discharge pistons 53, 58 in the cartridges 52, 54. The contents of the cartridges 52, 54 are mixed in the static mixer in the discharge tube by the pressure on the discharge pistons 53, 58, thereby producing the dental material, such as a dental impression material. The dental material is dispensed from the cartridges 52, 54 and from the discharge opening 78 and can be filled into the container, in particular the impression tray.

The amount of the dispensed volume and the volume flow of the dental material is controlled by the volume flow measuring device and calculated with the aid of the processor. The volume of dental material dispensed by the dispensing device is determined. The control system uses the processor to stop the motor 55 and thus the actuator of the dispensing device when a target volume of dispensed dental material is reached. In addition, the volume flow of the dispensed dental material can be controlled to set a target volume flow.

In addition to the volumes and volume flows stored in the memory, an individually determined volume and an individually defined volume flow and temporal progression of a volume flow can also be stored. For this purpose, the input device 64 can be used to enter that the subsequent volume or volume flow or subsequent temporal volume flow curve is to be linked to a previously selected assignment (for example, a specific key 66). A volume and/or volume flow and/or temporal volume flow of the dental material is then manually dispensed from the cartridge system 51 (for example, by pressing a specific key 66) and the volume and/or volume flow is determined using the volume flow measuring device. When the dispensing process is completed, the dispensed quantity (volume) of the dental material can be stored in the memory and later retrieved and automatically dispensed. Similarly, a specific temporal volume flow curve can be generated, stored, and later selected, retrieved, and reproduced.

The features of the invention disclosed in the above description and the Claims, drawings and embodiments can be essential to the implementation of the invention in the various embodiments thereof, both individually and in any desired combination.

### List of Reference Numerals

1,51 cartridge system
2, 52,54 cartridge
3,53,58 discharging plunger
4 Starting component for dental material
5,55 motor
6,56 holder
7,57 motor control
8 actuator
9,59 sensor
10 processor
11,61 sensor
12 connection/line
14,64 input device
16,66 buttons
18,68 display
19 residual time calculation module
20,70 housing
21 memory
22,72 lid
24 hinge
26 stop
28,78 discharge opening
30,80 conduit
32 strut
34 scanner/identification sensor
38,88 reader
40 container/dental impression tray
42 handle
44 cavity
46 identifier
60 housing above processor
74 lid handle
76 base

1. Dispensing device for dispensing a dental material, in particular a dental impression material, from a cartridge system the dispensing device comprising a motor in particular a stepper motor, the dispensing device further comprising a holder for attaching a cartridge system a motor control an actuator, and a volume flow measuring device for determining the volume or a volume flow of a dental material dispensed from the dispensing device, wherein at least one discharge piston of a cartridge system fixed in the dispensing device with the holder is propellable by the actuator, wherein the actuator is drivable with the motor or a mechanically transmitted driving of the actuator is supportable by the motor, wherein the volume flow measuring device has at least one sensor wherein the at least one sensor is connected to a processor for evaluating measurement signals from the at least one sensor wherein the processor is connected to the motor control and wherein the processor is designed or programmed to evaluate the measurement signals in such a way that the volume or volume flow of the dental material dispensed from the cartridge system by the propulsion of the at least one discharge piston from the cartridge system is determinable.

2. Dispensing device according to claim 1, wherein:
the at least one sensor is a volume flow sensor, a step counter for determining the number of revolutions of the motor in particular a step counter for determining the number of steps of the stepper motor, and/or a position sensor for determining the position of the at least one discharge piston and/or the actuator relative to the holder for fastening the cartridge system wherein the dispensed volume of the dental material is determinable by measuring the volume flow of the dental material with the volume flow sensor and/or by determining the number of revolutions of the motor or the steps of the stepper motor and a known volume of the dispensed dental material per revolution of the motor or per step of the stepper motor and/or by determining the position of the at least one discharge piston and/or the actuator and a known volume of the dispensed dental material per unit length of the position of the at least one discharge piston and/or the actuator relative to the holder

3. Dispensing device according to claim 1, wherein:
the dispensing device has a volume flow regulator, wherein the volume flow regulator is connected to the volume flow measuring device and the motor control and wherein
a volume of the dental material to be dispensed from the dispensing device is controllable and/or adjustable by the volume flow regulator and/or
a volume flow of the dental material dispensed from the dispensing device is controllable and/or adjustable by the volume flow regulator.

4. Dispensing device according to claim 1, wherein:
the dispensing device has an electronic memory and an input device, wherein several different volumes are selectable via the input device and, by means of the motor control, the selected volumes are extrudable fully automatically by the dispensing device from a cartridge system fixed by the holder in the dispensing device.

6. Dispensing device according to claim 4, wherein:
the several different volumes that are selectable via the input device are identifiable at the input device by a label on a container to be filled with the dental material, in particular by means of a number and/or letter identification of the container to be filled with the dental material so that the input is uniquely assigned to a container with a suitable volume for receiving the dental material, wherein optionally
the container is an impression tray and the dental material is a dental impression compound.

7. Dispensing device according to claim 1, wherein:
the dispensing device has a residual quantity indicator and a residual quantity calculation module, wherein the residual quantity calculation module is connected to the volume flow measuring device and wherein the residual quantity calculation module is programmed such that it determines, stores, or reads-in the producible volume of dental material by the cartridge system fixed to the holder when in completely filled state, or the producible volume of dental material is definable by an input, and the residual quantity calculation module subtracts the volume previously produced with this cartridge system from this producible volume of dental material in order to calculate a residual quantity, whereby the residual quantity calculated with the residual quantity calculation module is displayable on the residual quantity display.

8. Dispensing device according to claim 7, that wherein:
the residual quantity calculation module is programmed such that, when a small residual quantity is calculated, it selects a suitable container, in particular a dental impression tray, with a receiving volume suiting to the remaining residual quantity and suggests the suitable container on the residual quantity display and/or
the residual quantity calculation module is programmed such that, when a volume to be dispensed is selected which, according to the calculated residual quantity, is no longer contained in the attached cartridge system or cannot be produced with it, a corresponding message is displayed on the residual quantity display, in particular a prompt to change the cartridge system, and/or a maximum available volume of the dental material is displayed.

9. Dispensing device according to claim 1, wherein:
the dispensing device has a scanner for reading an identifier of the cartridge system attached to the holder or an identification sensor for identifying the cartridge system attached to the holder, wherein optionally the identifier read by the scanner or the identification determined by the identification sensor is optionally transmitted to the processor or to the residual quantity calculation module for identifying the contents of the cartridge system and/or the volume of dental material that is producible with the cartridge system.

10. Dispensing device according to claim 1, wherein:
the dispensing device is suitable for extruding cartridge systems for dental impression materials, in particular two-component cartridges for dental impression materials, wherein optionally the cartridge system provides a volume of between 100 ml and 1000 ml of dental impression material, optionally a volume of between 250 ml and 600 ml of dental impression material, and optionally a volume of between 300 ml and 500 ml of dental impression material.

11. Dispensing device according to claim 1, wherein:
the dispensing device is suitable for extruding cartridge systems at least for dental impression materials of type 1 and/or type 2 according to DIN ISO 4823:2015.

12. Dispensing device according to claim 1, wherein:
the dispensing device has a reader for reading an identifier of a container, in particular a dental impression tray, wherein the reader is connected to the processor and the processor is programmed such that, depending on the container recognized by the reader in particular the recognized dental impression tray recognized by the reader a volume, a volume flow and/or a time curve of the volume flow suitable for the recognized container, in particular for the recognized dental impression tray, is selectable and providable by corresponding control of the motor.

13. Method for dispensing a dental material, in particular of a dental impression material, from a cartridge system by means of a dispensing device, comprising the steps:
Securing the cartridge system in the dispensing device,
Actuating an actuator of the dispensing device with a motor, wherein the actuator drives at least one discharge piston of the cartridge system in at least one cartridge of the cartridge system forward,
a dental material or starting components of the dental material from the cartridge system by driving the at least one discharge piston in the at least one cartridge forward, whereby the dental material is dispensed from the at least one cartridge or is produced by mixing and dispensing the starting components from the at least one cartridge,
Measuring the volume flow and/or the volume of the dental material dispensed by the dispensing device and determining the volume of dental material dispensed by the dispensing device, and
Stopping the actuation of the actuator of the dispensing device when a target volume of the dispensed dental material is reached and/or controlling the volume flow of the dispensed dental material in order to set a target volume flow of the dispensed dental material or to set a desired time curve of the volume flow of the dispensed dental material.

14. Method according to claim 13, wherein:
the method is carried out using a dispensing device according to claim 1.

15. Method according to claim 13, wherein:
the target volume and/or the target volume flow and/or the desired time curve of the volume flow is or are determined and defined by previously dispensing dental material with manual settings and measuring the volume flow and/or the volume, wherein optionally the target volume and/or the target volume flow and/or the desired time curve of the volume flow is or are retrievably stored in an electronic memory, optional that the time curve of the dispensing process is additionally stored in the electronic memory.

16. Method according to claim 13, wherein:
the target volume is selected from a plurality of previously stored target volumes, optionally selected to match a plurality of containers for receiving the dental material, and/or
the target volume flow is selected from a plurality of previously stored target volume flows, optionally selected to match a plurality of containers for receiving the dental material, and/or
the desired time curve of the volume flow is selected from a plurality of previously stored time curves of volume flows, optionally selected to match a plurality of containers for receiving the dental material.

17. Method according to claim 13, wherein:
the volume of dental material dispensed by the dispensing device, determined by measuring the volume flow and/or the volume and/or the timer curve of the volume flow, is subtracted from a known residual amount of the available dental material that is extrudable from the cartridge system and the remaining quantity is displayed on a display and/or is taken into account in a subsequent dispensing process in such a way that the dispensing process is only started if a sufficient remaining quantity for the volume of dental material to be dispensed is available in the cartridge system and otherwise a warning or a prompt to change the cartridge system is displayed.

18. Method according to claim 13, wherein:
the dispensing device has a scanner for reading an identifier of the cartridge system fixed in the holder or has an identification sensor for identifying the cartridge system fixed in the holder, wherein the identifier of the cartridge system read by the scanner or the identification of the cartridge system is determined by the identification sensor and subsequently the identifier or the identification is used to identify the contents of the cartridge system and/or the volume of dental material that can be produced with the cartridge system wherein optionally the identifier or identification is taken into account during the dispensing process, at the start of the dispensing process, and/or during a calculation of the remaining quantity available in the cartridge system.

19. Method according to any claim 13, wherein:
the dispensing device has a reader for reading a machine-readable identifier of a container, in particular of a dental impression tray, wherein the identifier is read and subsequently the identifier is used to identify the container, in particular a shape or a volume of a cavity of the dental impression tray as a container, wherein the target volume, the volume flow and/or the time curve of the volume flow of the dental material is set or controlled as a function of the identifier of the container.

20. Dental impression tray for receiving a dental impression material, the dental impression tray comprising a handle for holding the dental impression tray and a cavity for receiving the dental impression material, wherein the dental impression tray has a machine-readable identifier arranged on an outward-facing surface of the dental impression tray, preferably arranged on a side of the surface of the impression tray opposite the handle, wherein the machine-readable identifier contains information from which the geometric shape, volume, length, and/or width of the cavity can be read.

21. Dental impression tray according to claim 20, wherein:
the machine-readable identifier is a hologram, a barcode, a QR code, a machine-readable label, a graphic imprint, a machine-readable sticker, or an RFID chip, optionally a hologram, a barcode, a QR code, or an RFID chip.

22. Plurality of dental impression trays according to claim 20, wherein:
each dental impression tray has a different machine-readable identifier that allows identification of the shape and/or volume of the cavity.

23. System for taking an impression with a dental impression material, comprising a dispensing device according to claim 12 and at least one dental impression tray for receiving a dental impression material, the dental impression tray comprising a handle for holding the dental impression tray and a cavity for receiving the dental impression material, wherein the dental impression tray has a machine-readable identifier arranged on an outward-facing surface of the dental impression tray, optionally arranged on a side of the surface of the impression tray opposite the handle, wherein the machine-readable identifier contains information from which the geometric shape, volume, length, and/or width of the cavity can be read.

24. System for taking an impression with a dental impression material, comprising a dispensing device according to claim 12 and at least one dental impression tray for receiving a dental impression material, the dental impression tray comprising a handle for holding the dental impression tray and a cavity for receiving the dental impression material, wherein the dental impression tray has a machine-readable identifier arranged on an outward-facing surface of the dental impression tray, optionally arranged on a side of the surface of the impression tray opposite the handle, wherein the machine-readable identifier contains information from which the geometric shape, volume, length, and/or width of the cavity can be read, wherein each dental impression tray has a different machine-readable identifier [that allows identification of the shape and/or volume of the cavity.
